(19) United States
(12) Patent Application Publication
(10) Pub. No.: US 2009/0191057 A1
(43) Pub. Date: Jul. 30, 2009

(54) Multi-Axis Wind Turbine With Power Concentrator Sail

(76) Inventor: Roger C. Knutson, Indianapolis, IN (US)

Correspondence Address: Bruce J. Bownan;Bowman & Associates, Suite 106, 1016 3rd Ave. SW, Carmel, IN, 46032, US

(21) Appl. No.: 12/359,301

(22) Filed: Jan. 24, 2009

Related U.S. Application Data
(60) Provisional application No. 61/062,247, filed on Jan. 24, 2008.

(51) Int. Cl. F03D 3/04; F03D 9/00

(52) U.S. Cl. 416/23; 416/1; 290/55

(57) ABSTRACT

A wind energy to electrical power conversion device provides a protected multiple turbine mechanism axially aligned to convert kinetic energy of air movement, i.e. wind (or other moving fluid such as water), into rotational mechanical power to directly create electrical energy by the reaction of the wind with the turbine. The present wind energy to electrical power conversion device may either be configured as a vertical axis wind turbine (VAWT) or horizontal axis wind turbine (HAWT). An associated wind gathering sail automatically repositions itself to maximize wind intake and to collect and concentrate the wind prior to converting the wind into energy via the axially aligned multi-turbine mechanism into electrical energy. The remaining wind is released via a leeward-facing exhaust. The present axially aligned multi-turbine mechanism avoids interference by birds and other outside objects due to its inherent structural visibility.

### RELATED APPLICATIONS

This patent application claims the benefit of and/or priority to U.S. Provisional Patent Application Ser. No. 61/062,247 filed Jan. 24, 2008, entitled “Power Concentrator Sail and Multi-Axis Wind Turbine” the entire contents of which is specifically incorporated herein by this reference.

### BACKGROUND OF THE INVENTION

1. Field of the Invention

The present invention relates to wind turbines utilized to convert wind energy into electro-mechanical energy and, more specifically, to vertical axis wind turbines for directly producing electrical energy.

2. Background Information

Wind as a source of energy is a development that has existed from distant historical accounts. There is evidence which indicates windmills were in use in Babylon and in China as early as 2000 B.C.

Wind is presently used as a source of energy for driving horizontal axis and vertical axis windmills. Horizontal axis windmills have been used extensively to drive electrical generators, however they suffer from several disadvantages, including the need for an even horizontal air inflow, danger to birds and air traffic, obscuring the landscape with banks of rotating windmills, and in the case of large diameter horizontal axis propellers, supersonic speeds at the tips of the rotors.

Compared to vertical axis wind turbines (VAWT) where its exposure remains constant regardless of the wind direction, a horizontal axis wind turbine (HAWT) must turn to face the wind direction. This disadvantageously adds additional moving parts to the wind gathering and electrical energy producing parts.

An example of a VAWT is shown in U.S. Pat. No. 5,391,926 issued to Staley et al. that uses double curved stator blades to direct wind current to the rotor assembly and to increase structure stability of the thin stator blades. U.S. Pat. No. 6,015,258 issued to Taylor discloses another wind turbine that includes a ring of stator blades of an airfoil shape to reduce impedance of air directed towards the central rotor assembly. Further, U.S. Patent Publication No. 2002/0047276 AI by Elder discloses an outer ring of planar stator blades to direct flow of wind into a central rotor assembly.

Furthermore, Canadian Patent No. 1,126,656 to Sharak discloses a vertical axis turbine with stator blades that redirect airflow to the rotor blades by extending vertical air guide panels that intermittently surround the rotor unit and direct air currents to the rotor unit for rotation by the wind. The air guide panels are closed at the top and bottom by horizontally extending guide panels that are canted in complementary directions. The upper panel is tilted downwardly as it progresses inwardly and the lower panel is tilted upwardly on its inward extent to thereby increase the velocity and pressure of the wind as it is directed to the rotor unit.

Another Canadian Patent Application No. 2,349,443 to Tetrault discloses a new concept of VAWT comprising an air intake module that redirects the airflow vertically into a series of rings with parabolic evacuations. A major drawback of this design is the fact that the air intake module needs to face the wind, so it requires a yaw mechanism to orient it into the wind. Moreover, the whole design forces the airflow to change its direction from horizontal to vertical into a sort of internal enclosure from where the air is evacuated by changing again its direction from vertical to horizontal. The numerous and drastic changes in airflow directions entail a power loss in the airflow and a reduction of the turbine efficiency, as the energy of the wind is transformed into rotation of the turbine only at the last airflow direction change.

A disadvantage of the entire propeller based horizontal and vertical axis windmills or wind turbines of the prior art relates to their inability to gather and translate large amounts of wind into energy via a VAWT. Ideally, the airflow exiting a blade will be used to a higher degree. Unfortunately, in most cases the prior art enables the capture of only a fraction, the first impulse, of the wind power.

It is noted that a prior art that uses properties of a fluid to transform efficiently a linear fluid movement into a rotational mechanical movement is the turbine described in U.S. Pat. No. 1,061,142 issued to Nikola Tesla in 1913 (the Tesla Turbine). The Tesla turbine used a plurality of rotating disks enclosed inside a volute casing and the rotation of the turbine was due to a viscous high-pressured fluid, oil in Tesla experiments, directed tangentially to the disks. Unfortunately this previous art is not suited to capture wind energy for several reasons such as the air viscosity is too low, the normal wind speed is too low and the whole design with a casing enclosure and only one access opening is impractical for wind turbines.

It is thus evident from the above discussion that there is a need for a simpler and/or more efficient wind to electrical energy conversion device.

### SUMMARY OF THE INVENTION

The present invention is a vertical axis wind turbine, and method of using wind to produce electricity, having a sail assembly having a forward, wind facing, planar tangentially surface coupled directly to a stabilizing downwind tail that redirects wind into an enclosure formed by the rotor blades, and a rotor assembly positioned within a cage enclosure with at least one magnetic elevation bearing that allows the rotor to spin with a minimum of mechanical friction with respect to a stator winding.

The present wind turbine is able to operate in very broad wind conditions, such as velocities up to 100 mph, and frequently changing wind directions. The sail of the present wind turbine provides a reliable and effective means for directing air currents into the rotor assembly, which can be attached directly to a vertical shaft or serve as a rotor to an integrated alternator.

The invention involves various embodiments of a vertical-axis wind turbine. Preferably, the stator windings are designed as a stationary core to the blade assembly(ies) and attached to the cage, therefore residing inside the rotor cylinder. The position of the sail also prevents the disruption of rotation by shielding the rotor vanes from winds counter-directional to their rotation which may occur as the wind shifts. The turbine may be equipped with any number of stator blades; however a preferred embodiment has between four and six blades.

The present invention can also act to convert wind currents into mechanical energy to be used to directly act upon a water pump, or to drive an electrical generator alternator via a shaft coupled to the rotor.

It is thus a preferred object of the present invention to provide a vertical axis wind turbine which enables the capture and conversion of wind energy.

It is a further preferred object of the invention to provide a rotor/stator assembly that is structurally reinforced by a cage that supports a sail and magnetic levitation bearing assembly.

It is a still further preferred object of the invention to provide a rotor/stator assembly that is simply constructed of inexpensive light material and is partially supported and precisely constrained through the use of a magnetic/levitation bearing.

### BRIEF DESCRIPTION OF THE DRAWINGS

The above mentioned and other features, advantages and objects of this invention, and the manner of attaining them, will become apparent and the invention itself will be better understood by reference to the following description of embodiments of the invention taken in conjunction with the accompanying drawings, wherein:

FIG. 1 is a top perspective view of an exemplary embodiment of wind turbine with a power concentrator sail (wind turbine) fashioned in accordance with the principles of the present invention;

FIG. 2 is an enlarged portion of the wind turbine of FIG. 1 particularly illustrating the turbine assembly thereof;

FIG. 3 is an enlarged section of the enlarged portion of FIG. 2 particularly illustrating a vane assembly of the turbine assembly;

FIG. 4 is an enlarged portion of the wind turbine of FIG. 1 particularly illustrating an alternator/generator portion of the wind turbine positioned at the base thereof;

FIG. 5 an enlarged portion of the wind turbine of Fig. particularly illustrating the connection of the concentrator sail to the wind turbine assembly;

FIG. 6 is a sectional view of an alternative embodiment of a vane assembly incorporating an electrical energy generator (stator/rotor);

FIG. 7 is an enlarged perspective view of the trailing sail of the concentrator sail of the wind turbine of FIG. 1;

FIG. 8 is an enlarged, cross-sectional view of the stator/rotor/vane assembly of FIG. 6 taken along line 8-8 thereof;

FIG. 9 is an enlarged cross-sectional view of a magnetic levitation assembly for the present wind turbine;

FIG. 10 is a flow diagram of control and CPU functions of the present wind turbine; and

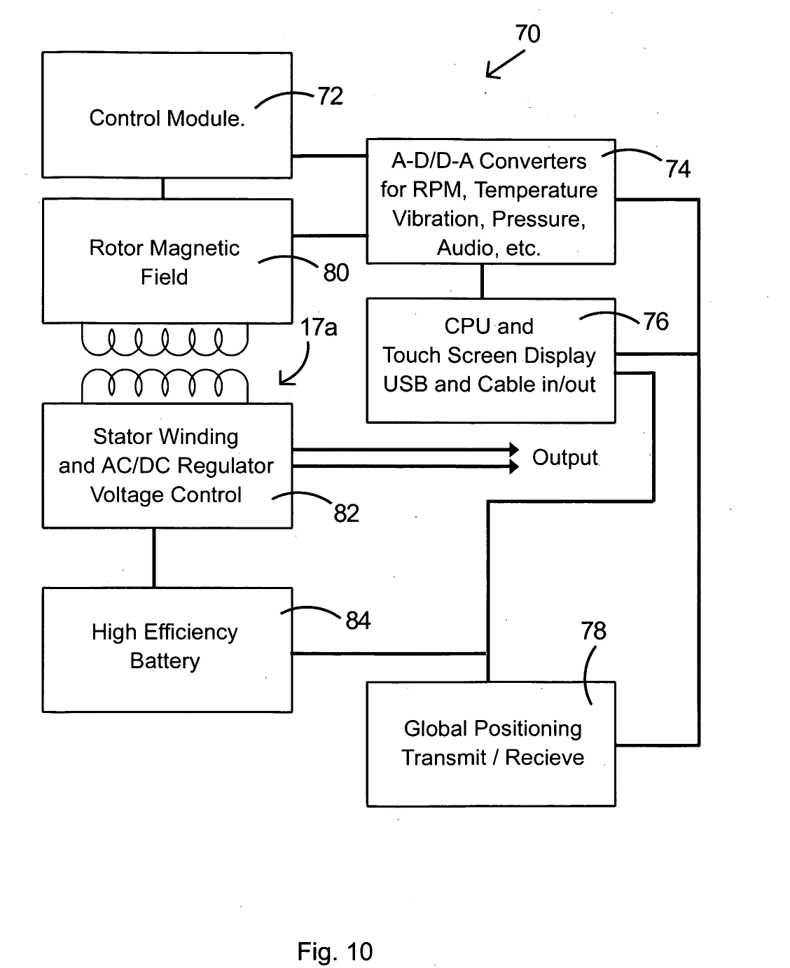

FIG. 11 is a side view of the wind turbine of FIG. 1.

Like reference numerals indicate the same or similar parts throughout the several figures.

A complete discussion of the features, functions and/or configuration of the components depicted in the various figures will now be presented. It should be appreciated that not all of the features of the components of the figures are necessarily described. Some of these non discussed features as well as discussed features are inherent from the figures. Other non discussed features may be inherent in component geometry and/or configuration.

### DETAILED DESCRIPTION OF EMBODIMENTS OF THE INVENTION

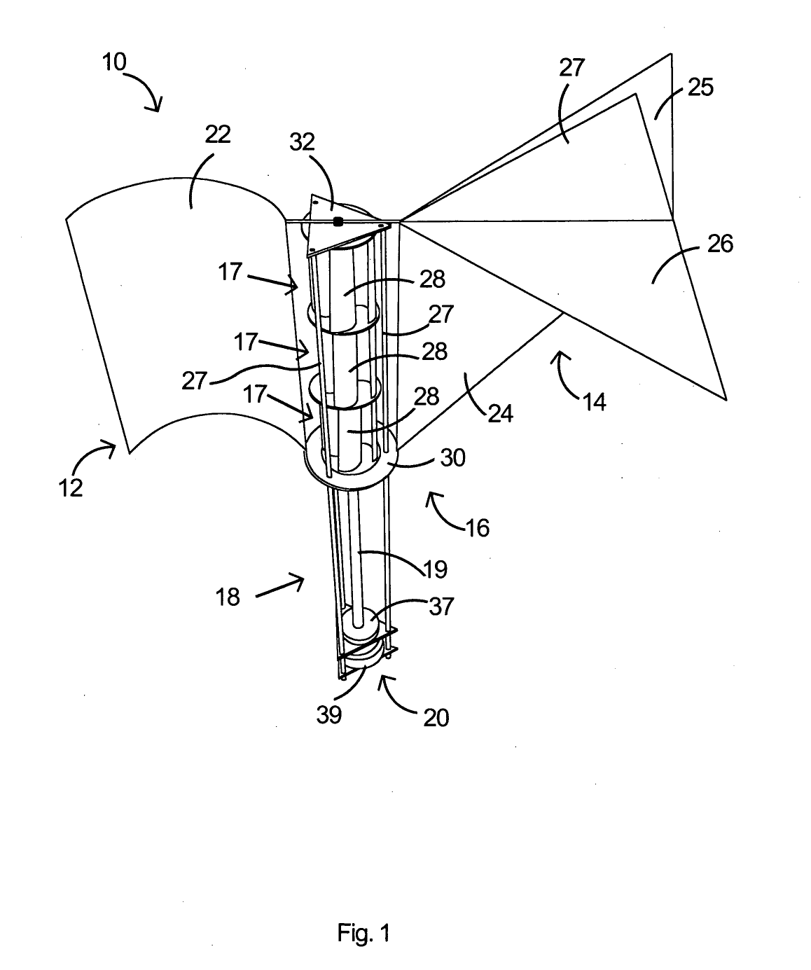

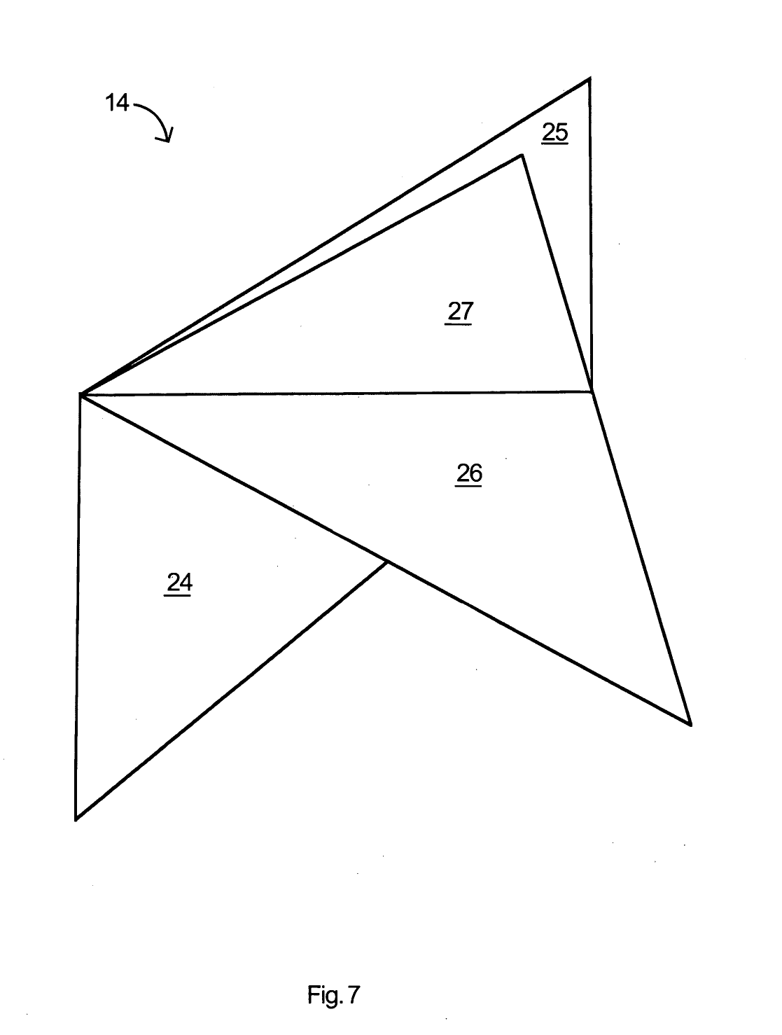

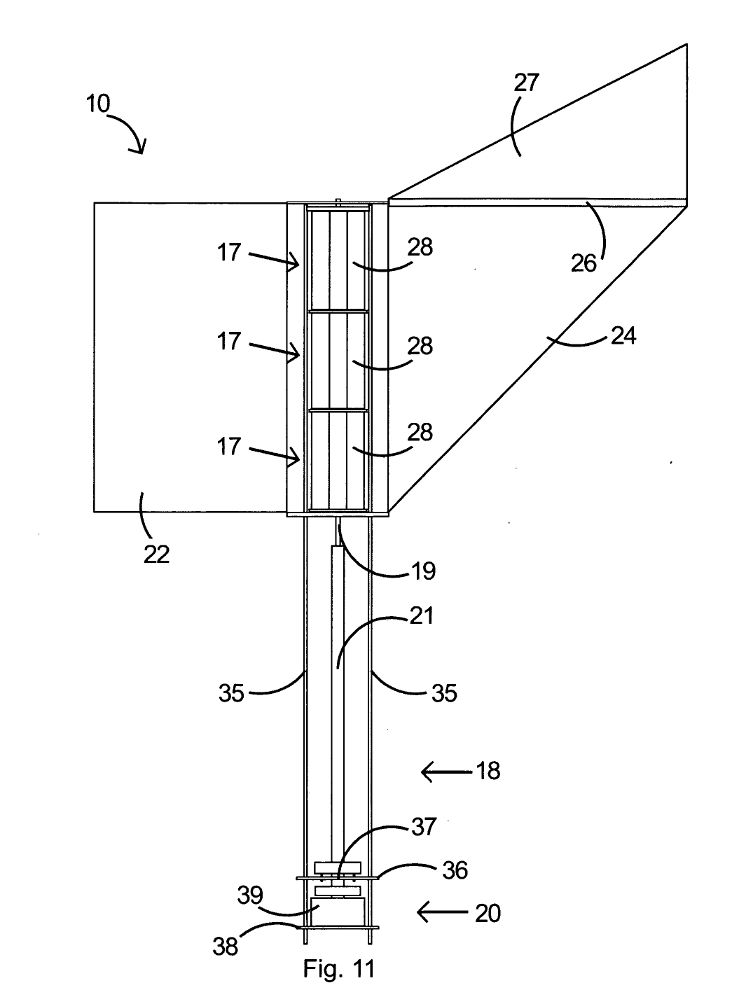

FIGS. 1 and 11 show a vertical axis wind turbine (VAWT) 10 as seen from the exterior thereof, having a front sail 12, a trailing or tail sail 14, a turbine assembly 16 (e.g. Savonius turbines), and electricity generator section 20, all on a base or stand 18. The turbine assembly 16 is shown having a plurality (3) of wind vane assemblies 17. It should be appreciated, however, that the turbine assembly 16 may have only one vane assembly 17, two or more that three vane assemblies 17 as desired. The incident wind is captured and directed into the rotor vanes 28 of each vane assembly 17 via the front sail 12. The position of the front sail 12 with respect to the wind is maintained by the tail sail 14. The front sail 12 is characterized by a curved panel 22 that directs the wind into the vane assemblies 17. The tail sail 14, as best seen in FIG. 7, includes a front panel 24, left and right cross panels 26, 25 and vertical panel 27. This configuration is similar to the tail of an airplane.

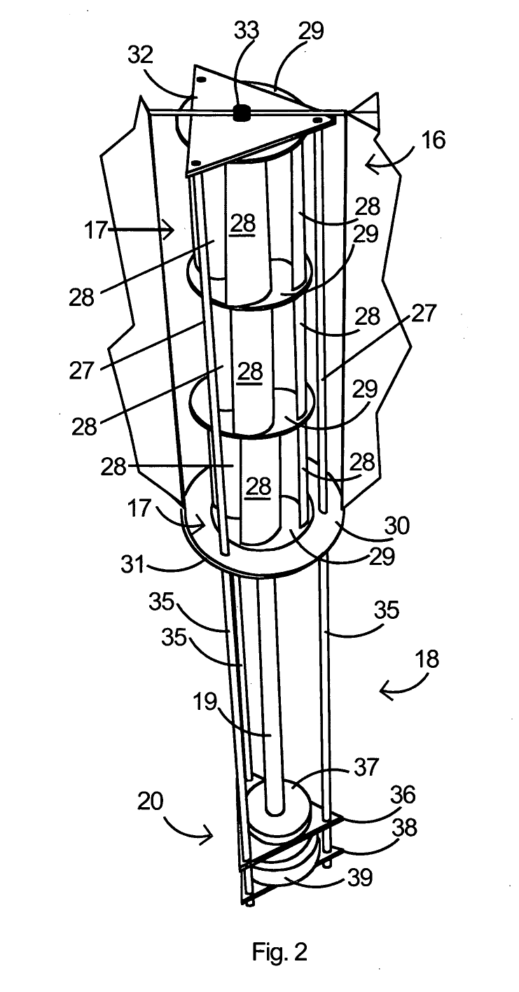

FIG. 2 shows the present vertical axis wind turbine 10 where the sail is out of frame to better illustrate turbine assembly 16 and more particularly, the vane assemblies 17. The vane assemblies 17 are held by an upper plate 32 and a lower plate 30 separated by rods 28. Each vane assembly 17 includes a number of curved vanes or blades 28 that are attached to a central shaft 19 and to upper and lower plates 29. In the embodiment shown, each vane assembly 17 has four (4) vanes or blades 28 but the number may change as necessary. The blade's rotation is counter clockwise. It will be understood of course that the orientation of the sail and the blades may be reversed to drive the turbine in a clockwise direction if desired.

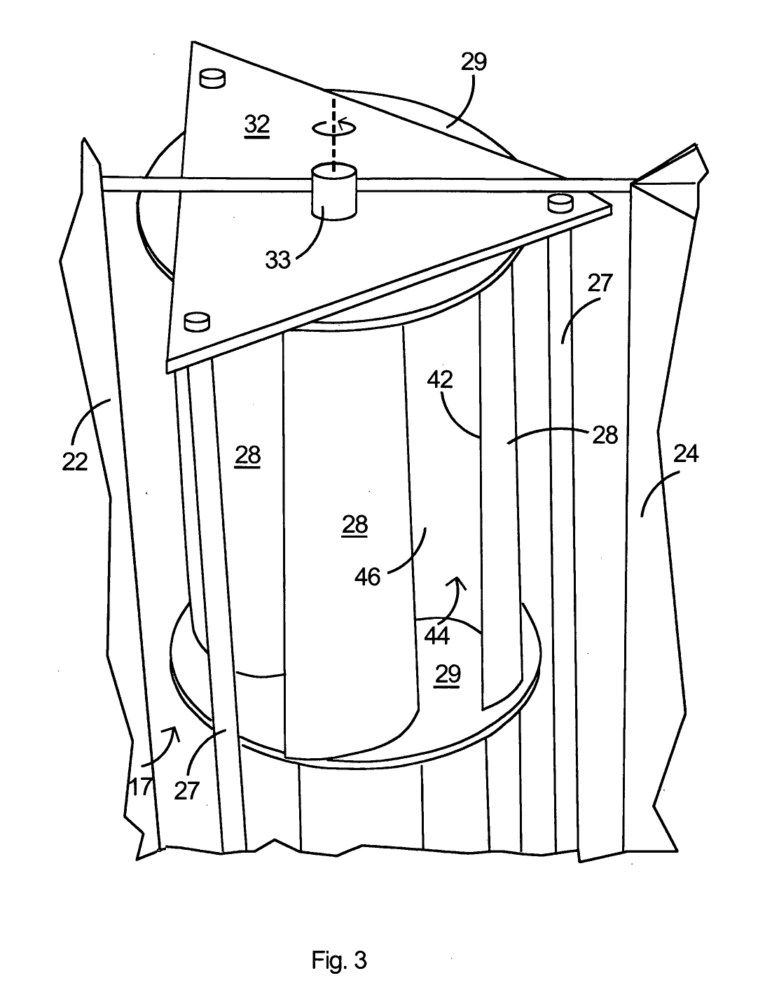

Referring to FIG. 3, the air inflow will be redirected tangentially into the vane assembly to rotate the blades 28. Each blade 28 has a vertical edge 42 which when facing the wind will capture the air flow into its air channel 46. The outward surface has a smooth convex curvature between the exterior point of the rotor blade and the tangential point of the internal rotor circumference. The blades are preferably manufactured from a corrosion resistant light material, such as reinforced fiber glass composite, to rotate very easily even in slow wind. The blades 28 are preferably, but not necessarily, uniformly distributed on the circumference of the disk 29. The disk 29 may be equipped with any number of blades, however in the preferred embodiment the number of blades is four.

The top and bottom plates of the turbine assembly 16 have a bearing assembly fastener 33 that is attached to sail assembly struts and allows the front and tail sails 12, 14 to rotate around the pole/shaft 19 center-line. The circular bearing allows the sail assembly to position the front sail surface to face into the wind at precisely the exact angle to capture the optimum wind force for maximum rotor angular momentum. In addition the front sail 12 blocks the oncoming wind from impeding the rotation of the next vane thereby improving rotational performance of the unit. In one embodiment the front sail 12 support structure is connected to the rotor cage utilizing breakaway shear pins that would allow the front sail to fold back against the rotor cage in high wind conditions.

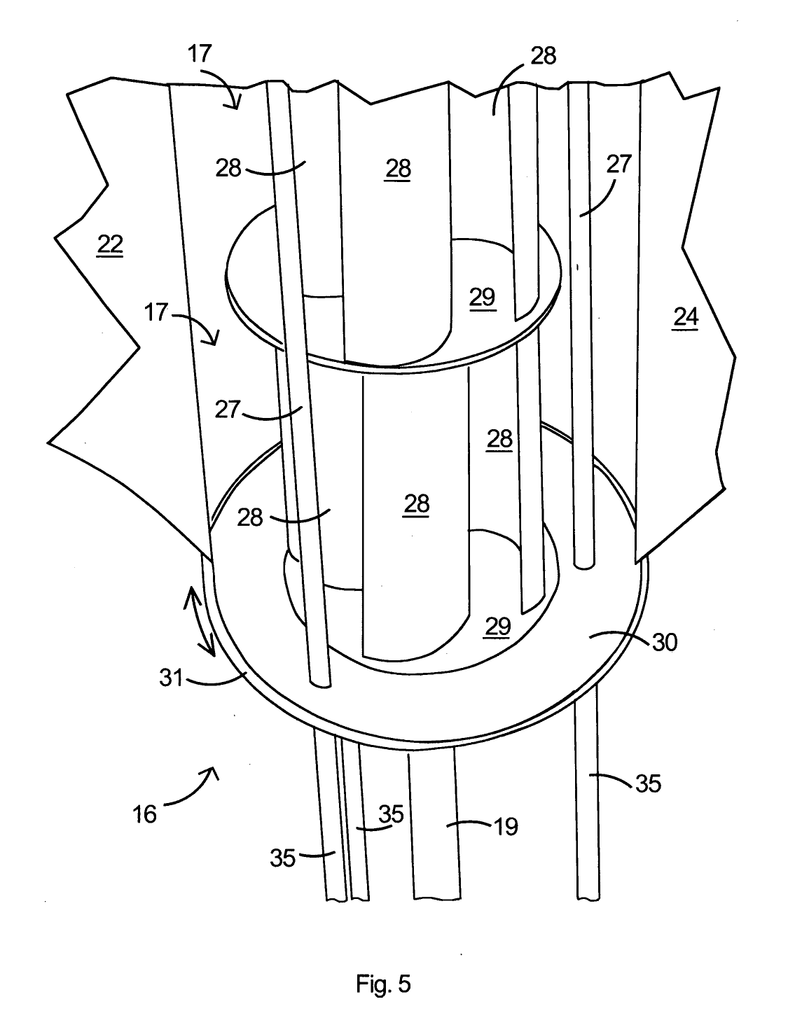

As best seen in FIG. 5, the bottom of the front sail panel 22 is connected to a ring 31 that is rotationally situated on the disk 30. The bottom of the tail sail panel 24 is likewise connected to the ring 31. This allows the sail to rotate about the turbine assembly 16 in order to capture and direct the wind into the vane assemblies 17.

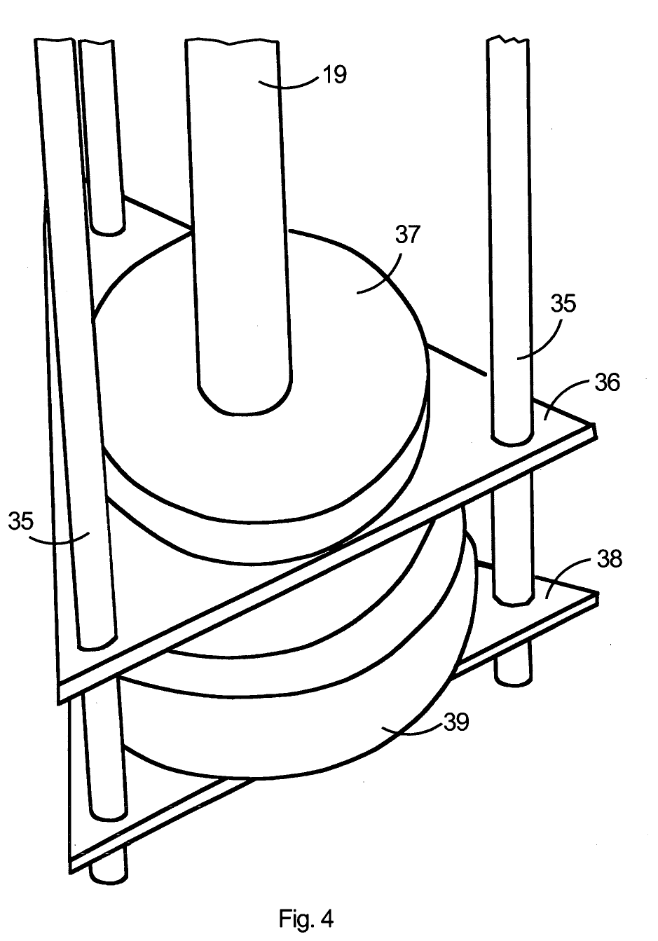

In one form, the vane assemblies 17 are connected to the shaft 19 such that rotation of the vanes 28 rotates the shaft 19 in order to generate electricity. The shaft 19 is connected through suitable gearing 37 held by plate 36 to an alternator/generator 39 held by plate 38 on the base 18 (see, e.g., FIG. 4). As the shaft 19 rotates, the alternator/generator 39 directly produces electricity.

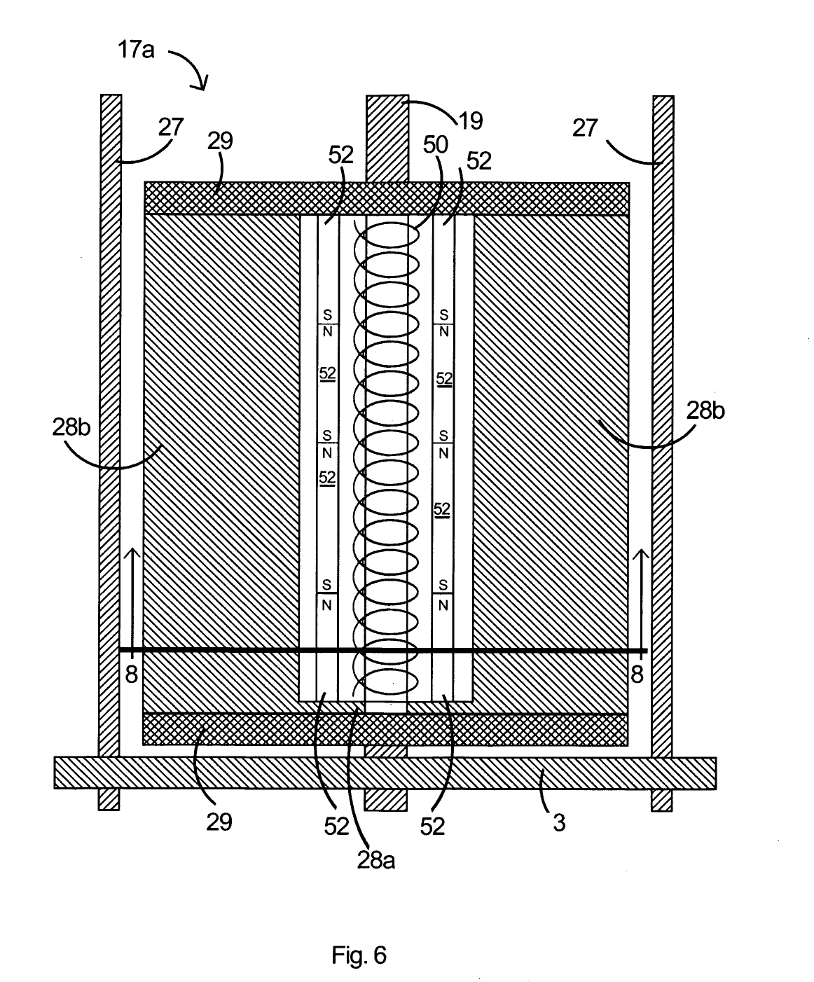

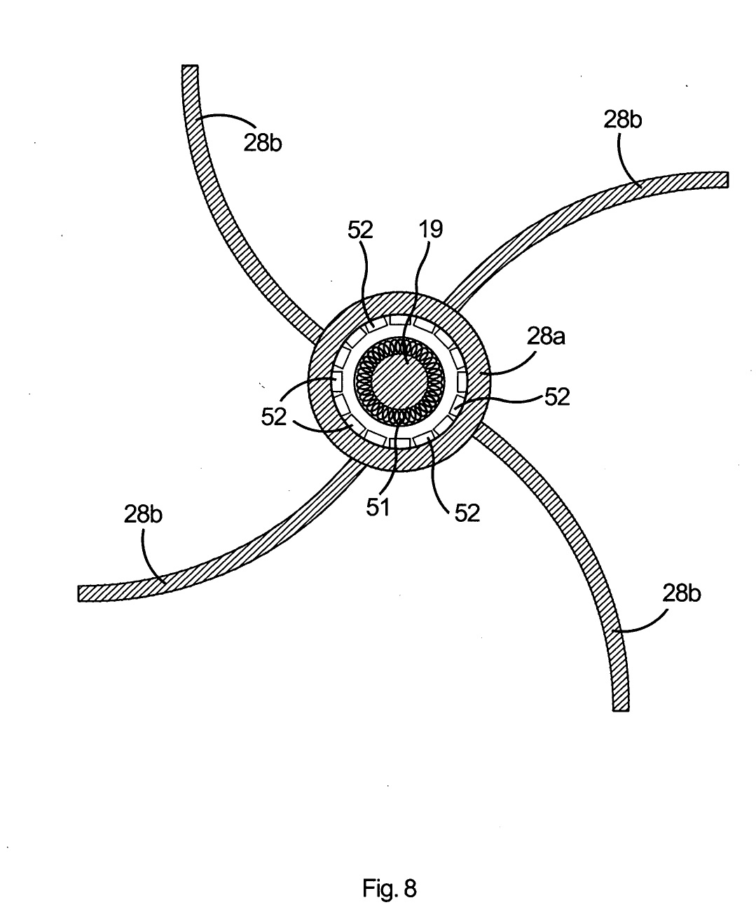

Referring to FIGS. 6 and 8, an alternative manner of producing electricity rather than through rotation of the shaft 19 and the use of the gearing 37 and alternator/generator 39 is to incorporate the rotor and stator into the vane assembly and shaft such that rotation of the vanes directly produces electricity. Particularly, the alternative vane assembly 17a includes an integral rotor vane having four blades 28b that extend from a hub 28a. The electrical power is generated by the rotation of the rotor vane with respect to an internal stator 50 of an appropriate set of magnet wire windings. A series of powerful magnets 52 are positioned accordingly in the rotor housing, in close proximity to the windings, which generate a moving magnetic field. In total the assembly 17a is an alternator/generator. The vane/stator structure 28b is preferably made from a more resistant non-corrosive material, such as a stronger type of polymer. The whole vertical axis turbine may be made from inexpensive plastic material to create a cost effective alternate power source. In some situations it may be beneficial to construct the rotor cage and supports from a light weight metal like aluminum providing additional structural integrity.

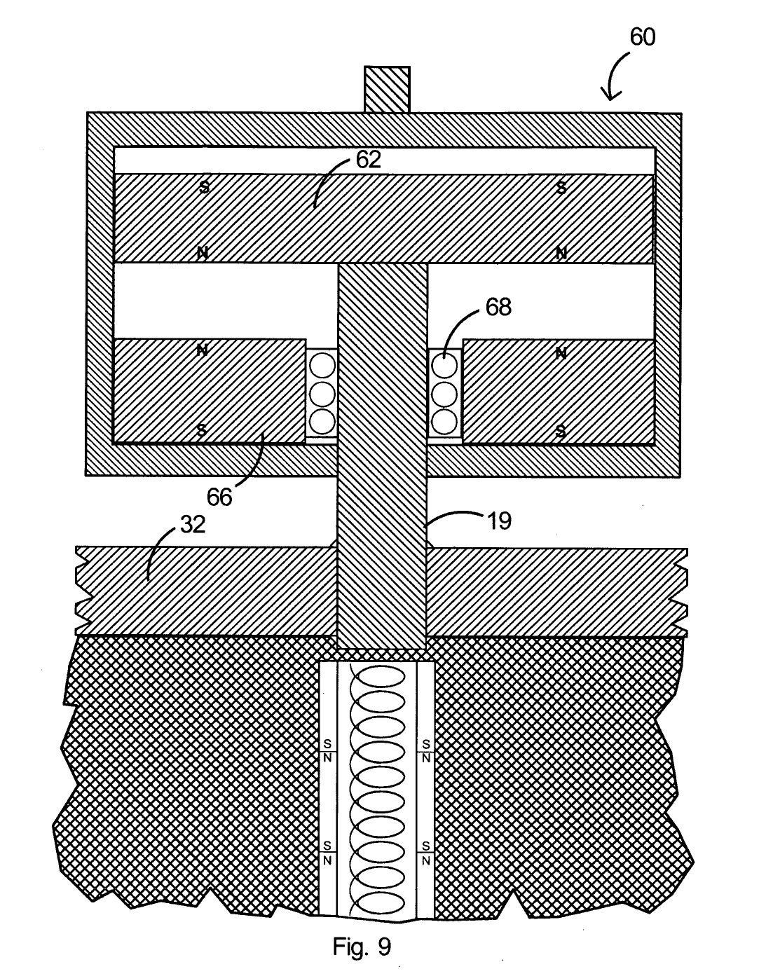

FIG. 9 shows a magnetic bearing assembly 60 that may be used with all embodiments even though the rotor/vane direct electricity approach is shown. The magnetic bearing assembly 60 consists of a top magnetic disk 62 that is connected to the shaft 19. The shaft 19 extends through bearings 68 and a second magnetic disk 66. The magnetic disks 62 and 66 are configured to oppose each other (i.e. North to North polarity). The magnetic disks 62, 66 are fabricated from a high magnetic flux material like neodymium-boron alloy. The magnetic disks 62, 66 are sized to support the weight of the rotor that they are connected to. The magnetic disk 62 is fixed in a stationary position on the shaft 16 at the top and/or bottom of the rotor assembly. The mating magnetic disk 66 is connected adjacent to the stationary disk providing a repulsive force to lift the entire assembly thereby greatly reducing friction. This allows the rotor/vane assembly to spin freely. Also, the magnetic bearing assembly 60 is preferably situated in a housing that is filled with a lubricating fluid of high magnetic permeability.

In all cases, the electric/electronic power generated is fed to the conversion controller 70 and initially into conversion control module (CMM) 72. The CMM 72 has an embedded CPU and touch screen display 76 to monitor an assortment of transducers and sensors internal to the wind turbine 10 that gathers performance data like temperature, vibration, wind velocity, vector acceleration, electrical parameters, etc. 74. This information can be viewed locally or transmitted to a maintenance center. Online and local connectors are available for download and/or programmatic updates. Proper operation of electrical energy from the alternator and conversion via inverters, D to A, A to D devices 74, battery backup 84, load stabilizing, etc is handled by the CMM 72 and CPU 76. The CMM 72 monitors the rotor magnetic field 80. The stator winding includes an AC/DC regulator voltage control 82. The system 70 may also include a global positioning transmitter/receiver 78.

In further alternate embodiments of the present wind turbine, the sail material used will also consist of a solar collecting surface. Moreover, the present wind turbine assembly can be mounted on an existing pole and/or structure. For example the unit could be positioned above a streetlight pole to power the light and also supply electrical energy to the existing utility grid. The rotor blades on the circumference of the assembly may be designed with a certain angle from the vertical and having a certain twist of the surface to increase the drag and lift effect. The surfaces of the rotor to create the boundary layer effect may be designed in different shapes instead of disks. The rotor vanes and disk openings may have any shape instead of arc sectors. The rotor may be designed to incorporate a shaft that extends to the base of the unit from the rotor housing. This shaft can be connected to a geared transmission for areas of highly variable winds.

The wind turbine can be disposed horizontally or at an angle with respect to the vertical with only one inflow opening facing the wind. Such embodiment may be used in places where the wind is known to have only one direction or it may be used in a configuration where the turbine is placed on objects in motion (such as cars, boats, etc.) to generate the required electrical power.

Although the above description relates to a specific preferred embodiment as presently contemplated by the inventor, it will be understood that the invention in its broad aspect includes mechanical and functional equivalents of the elements described herein. Without limiting the possibilities of alternate embodiments, it is described below some of such functional equivalents of the present vertical axis wind turbine 10.

While the invention has been illustrated and described in detail in the drawings and foregoing description, the same is to be considered as illustrative and not restrictive in character, it being understood that preferred embodiments have been shown and described and that all changes and modifications that come within the spirit of the invention are desired to be protected.

What is claimed is:

1. A method for converting wind energy to electrical energy from an ambient wind current, the method comprising the steps of:
rotating a sail structure into the wind at a most advantages angle for positioning an intake windward, the intake being substantially normal to a flow of the ambient wind current to receive the wind;
collecting the wind into a multiple set of Savonius turbines;
converting the concentrated wind into energy via the multiple turbines, each turbine having blades positioned substantially normal to the flow of the concentrated wind, and having an axis being stationary relative to a housing of the multiple turbines; and
directing the concentrated wind to a partially covered exhaust to release the concentrated wind in a substantially leeward direction.

2. The method as recited in claim 1, wherein the multiple turbines are positioned on top of the other along a vertical axis to share in equal portions of the concentrated wind.

3. The method as recited in claim 1, wherein the sail positioning includes rotating about a yaw axis the intake to obtain an optimum flow of the ambient wind current.

4. The method as recited in claim 1, further comprising determining whether the conversion is within operating thresholds.

5. The method as recited in claim 4, further comprising the step of repositioning the intake for optimal flow when operating outside of the operating thresholds.

6. The method as recited in claim 5, wherein the operating thresholds can include several operating zones, each operating zone being associated with one gear and/or the addition of an additional generator assembly.

7. The method as recited in claim 6, wherein upon determining that the conversion is operating within a specific operating zone shifting at least one generator to the associated gear is monitored and retained in software memory with other measurements like temperature, wind speed, direction, power output, power factor, efficiency, and vibration.

8. The method as recited in claim 1, wherein each turbine has an air flow channel, each channel is divided into substantially equal concentrator conduits, each conduit being configured to direct and to separate the wind for a different turbine.

9. A wind energy conversion assembly comprising:
a vertically aligned wind turbine assembly that is structurally mounted and secured for rotation at a position above the wind turbine assembly by means of a magnetic bearing device, the wind turbine assembly having a plurality of blades that are mounted at a position for a major portion of the plurality of blades to be substantially normal to the received wind from the intake interface;
an intake sail interfaced for receiving wind to rotating blades of the wind turbine assembly that are connected to a centered rotor that allows passage of the received wind there through; and
an exhaust for releasing the wind in a substantially leeward direction;
the wind turbine assembly being partially shielded from the wind and being operatively coupled to a generator stator shaft.

10. The wind energy conversion device according to claim 9, wherein the sail includes a concentrator channel coupled to the intake interface for concentrating the received wind and generating increased wind velocity.

11. The wind energy conversion assembly according to claim 10, wherein said turbine is coupled to said shaft and stator to convert the concentrated received wind into kinetic/mechanical/rotational energy.

12. The wind energy conversion assembly according to claim 10, wherein the concentrated wind at the outlet of the concentrator channel is at a pressure greater than that of the outside atmosphere.

13. The wind energy conversion assembly according to claim 10, further comprising multiple wind turbine assemblies that are mounted above one another with connectivity to the shaft to transfer power from the turbine, the shaft being coupled to a hub of at least one wind turbine assembly via a thrust bearing.

14. The wind energy conversion assembly according to claim 9, further comprising a converter wherein the converter includes a plurality of gear tracks, each gear track being associated with a specific operational threshold based in part on detected environmental conditions.

15. A system for generating power using wind, the system comprising:
at least one wind turbine oriented substantially perpendicular to a rotatable shaft and parallel to each other, each turbine having a plurality of balanced blades;
a divisible intake channel for collecting the wind, the divisible intake channel having at least one input and at least one output;
at least one concentrating sail coupled to the at least one output for concentrating the wind individually onto the at least one turbine;
an exhaust for releasing the wind from the least one turbine and to allow passage of wind through a wind sail/shield to divert a first portion of the wind into the divisible intake channel and a second portion of the wind around the system to prevent negative interference with the rotation of the at least one wind turbine.

16. The system according to claim 15, wherein the wind sail/shield dispenses the wind into receiving blade cavities of a wind turbine enclosure of the turbine blades except for a portion of the turbine not exposed to the concentrating channel.

17. The system according to claim 16. wherein a sail strut linkage, upon actuation, rotates the sail/shield intake channel in a windward direction to receive the wind.
